(19) United States
(12) Patent Application Publication
(10) Pub. No.: US 2026/0045685 A1
(43) Pub. Date: Feb. 12, 2026

(54) PIM SHIELDS FOR DUAL ANTENNAS AND RELATED ANTENNA AND PIM SHIELD ASSEMBLIES

(71) Applicant: Outdoor Wireless Networks LLC, Richardson, TX (US)

(72) Inventors: Paul Everest, Flower Mound, TX (US); Peter J. Bisiules, LaGrange Park, IL (US); Junfeng Yu, Plano, TX (US); Calvin Dickerson, Garland, TX (US)

(21) Appl. No.: 19/276,493

(22) Filed: Jul. 22, 2025

Related U.S. Application Data
(60) Provisional application No. 63/680,178, filed on Aug. 7, 2024.

(51) Int. Cl. H01Q 1/52; H01Q 1/00; H01Q 1/24; H01Q 15/00

(52) U.S. Cl. CPC H01Q 1/526; H01Q 1/002; H01Q 15/0013; H01Q 1/246

(57) ABSTRACT

A PIM shield is provided that extends laterally and longitudinally behind dual-antennas that are adjacently mounted side-by-side. The PIM shield can have a frequency selective surface that block or reflect signal at low and mid-band and that allows signal at high band to propagate therethrough. The PIM shield can be provided as two separate bodies, one behind a first one of the dual antennas and one behind a second one of the dual antennas.

### RELATED APPLICATIONS

This application claims the benefit of and priority to U.S. Provisional Patent Application Ser. No. 63/680,178, filed Aug. 7, 2024, the contents of which are hereby incorporated by reference herein.

### BACKGROUND

The present invention generally relates to radio communications and, more particularly, to base station antennas for cellular communications systems.

Cellular communications systems are well known in the art. In a cellular communications system, a geographic area is divided into a series of regions that are referred to as “cells” which are served by respective base stations. The base station may include one or more antennas that are configured to provide two-way radio frequency (“RF”) communications with mobile subscribers that are within the cell served by the base station. In many cases, each cell is divided into “sectors.” In one common configuration, a hexagonally shaped cell is divided into three 120° sectors in the azimuth plane, and each sector is served by one or more base station antennas. Each base station antenna includes one or more phase-controlled arrays of radiating elements that generate radiation patterns (also referred to herein as “antenna beams”). Typically, the base station antennas are mounted on a tower or other raised structure, with the antenna beams that are generated by the arrays of radiating elements directed outwardly.

In order to accommodate the increasing volume of cellular communications, cellular operators have added cellular service in a variety of new frequency bands. In order to increase capacity without further increasing the number of base station antennas, multi-band base station antennas have been introduced which include multiple linear arrays of radiating elements. Additionally, base station antennas are now being deployed that include “beamforming” arrays of radiating elements that include multiple columns of radiating elements that are connected to respective ports of a radio so that the antenna may perform active beamforming (i.e., the shapes of the antenna beams generated by the antenna may be adaptively changed to improve the performance of the antenna). In some cases, the radios for these beamforming arrays may be integrated into the antenna. These beamforming arrays typically operate in higher frequency bands, such as various portions of the 3.3-5.8 GHZ frequency band. Antennas having integrated radios that can adjust the amplitude and/or phase of the sub-components of an RF signal that are transmitted through individual radiating elements or small groups thereof are referred to as “active antennas.” Active antennas can generate narrowed beamwidth, high gain, antenna beams and can steer the generated antenna beams in different directions by changing the amplitudes and/or phases of the sub-components of RF signals that are transmitted through the antenna.

Further details of example conventional antennas can be found in co-pending WO2019/236203 and WO2020/072880, the contents of which are hereby incorporated by reference as if recited in full herein.

Passive inter-modulation distortion (“PIM”) is a form of electrical interference that may occur when two or more RF signals encounter non-linear electrical junctions or materials along an RF transmission path. Such non-linearities may act like a mixer causing the RF signals to generate new RF signals at mathematical combinations of the original RF signals. These newly generated RF signals are referred to as “inter-modulation products.” If RF signals transmitted through a device generate inter-modulation products that fall in the same bandwidth of RF signals that are received through the same device, the inter-modulation products effectively increase the noise level experienced by the existing RF signals in the receiver bandwidth. When the noise level is increased, it may be necessary to reduce the data rate and/or the quality of service. PIM can be an important interconnection quality characteristic, as PIM generated by a single low-quality interconnection may degrade the electrical performance of the entire RF communications system. Thus, ensuring that components used in RF communications systems will generate acceptably low levels of PIM may be desirable.

The above-described inter-modulation products arise because non-linear systems generate harmonics in response to sinusoidal inputs. For example, when a signal having a first frequency Sr is input to a non-linear system, then the resulting output signal will include signals at integer multiples of the input frequency. When two or more signals having different frequencies are input to a non-linear system, inter-modulation products arise. For example, consider a composite input signal x(t) to a non-linear system that includes signals at three different frequencies:

$$x ( t ) = {A}_{1} sin ( 2 π {f}_{1} t + {φ}_{1} ) + {A}_{2} sin ( 2 π {f}_{2} t + {φ}_{2} ) + {A}_{3} sin ( 2 π {f}_{3} t + {φ}_{3} ) \qquad EQN ( 1 )$$

In Equation (1) above, Aᵢ and φᵢ are the amplitudes and phases of the signals at the three different frequencies f₁, f₂, f₃. If these signals are passed through a non-linearity, the resulting output signal will include components at the frequencies f₁, f₂, f₃ of the three input signals, which are referred to as the fundamental components, as well as linear combinations of these fundamental components having the form:

$$k 1 f 1 + k 2 f 2 + k 3 f 3 \qquad EQN ( 2 )$$

where k₁, k₂, k₃ are arbitrary integers which can have positive or negative values. These components are the inter-modulation products and harmonics and will have amplitudes and phases that are a function of the non-linearity and the composite input signal x(t).

The order of an inter-modulation product is the sum of the absolute value of the coefficients kᵢ included in the inter-modulation product. In the above example where the composite input signal x(t) includes signals at three different frequencies, the third order inter-modulation products are the inter-modulation products where:

$$\vert k 1 \vert + \vert k 2 \vert + \vert k 3 \vert = 3 , where \vert k 1 \vert , \vert k 2 \vert , \vert k 3 \vert < 3 \qquad EQN ( 3 )$$

In the above example, the third-order inter-modulation products will be at the following frequencies:

$${f}_{1} + {f}_{2} - {f}_{3}$$

$${f}_{1} + {f}_{3} - {f}_{2}$$

$${f}_{2} + {f}_{3} - {f}_{1}$$

$$2 {f}_{1} - {f}_{2}$$

$$2 {f}_{1} - {f}_{3}$$

$$2 {f}_{2} - {f}_{1}$$

$$2 {f}_{2} - {f}_{3}$$

$$2 {f}_{3} - {f}_{1}$$

$$2 {f}_{3} - {f}_{2}$$

The odd-order inter-modulation products are typically of the most interest as these products are the ones that tend to fall in the vicinity of the frequencies of the fundamental components.

PIM may be caused by, for example, inconsistent metal-to-metal contacts along an RF transmission path, particularly when such inconsistent contacts are in high current density regions of the transmission path such as inside RF transmission lines, inside RF components, or on current carrying surfaces of an antenna. Such inconsistent metal-to-metal contacts may occur, for example, because of contaminated and/or oxidized signal carrying surfaces, loose connections between two connectors, metal flakes or shavings inside RF components or connections and/or poorly prepared soldered connections (e.g., a poor solder termination of a coaxial cable onto a printed circuit board). PIM may arise in a variety of different components of an RF communications system. For example, non-linearities may exist at the interconnections in an RF communications system where cables such as coaxial cables are connected to each other or to RF equipment. PIM may also arise in other components of an RF communications system such as radios, RF amplifiers, duplexers, cross-band couplers, interference mitigation filters and the like. PIM may also arise on or within radiating elements of the RF communications system such as parabolic antennas or phased array antenna elements. The non-linearities that give rise to PIM may be introduced at the time of manufacture, during installation, or due to electro-mechanical shift over time due to, for example, mechanical stress, vibration, thermal cycling, and/or material degradation.

In the past, RF absorption materials have been placed behind a passive antenna to try to ameliorate PIM from surrounding structures and/or other antenna.

There is a need for alternative solutions to suppress PIM in noisy RF environments.

### SUMMARY

Embodiments of the present invention are directed to side-by-side antennas coupled to a PIM shield.

The PIM shield can be configured to allow high band radiating elements to propagate electromagnetic waves therethrough and reflect lower band RF signals transmitted by lower band radiating elements.

The PIM shield can have a frequency selective surface (FSS).

The FSS can be configured to reflect or block electromagnetic waves from radiating elements of a passive base station antenna that operates in one or more lower frequency bands while allowing higher frequency band electromagnetic waves of the active antenna to travel therethrough.

The FSS can be provided, at least in part, by a sheet of metal arranged to provide a grid pattern of unit cells.

Embodiments of the present invention are directed to side-by-side antennas that each include: a housing with an external radome; a multi-column array of radiating elements in the housing; and a passive inter-modulation distortion (“PIM”) shield that is on, in and/or positioned about at least part of each of the housings. The PIM shield includes a frequency selective surface (FSS).

The FSS can be configured to reflect or block electromagnetic waves from radiating elements of a passive base station antenna that operates in one or more lower frequency bands while allowing higher frequency band electromagnetic waves of the active antenna to travel therethrough.

The PIM shield can have a first longitudinally extending body and a second longitudinally extending body with inner facing end portions that overlap or that reside adjacent but spaced apart from one another.

The first and second longitudinally extending bodies can each define a plurality of longitudinally extending windows, with at least one of the windows configured to receive a mounting bracket. The first and second longitudinally extending bodies may each have a bracket attachment projecting rearward adjacent at least one of the windows.

The PIM shield can have a rear wall with first and second laterally spaced apart and rearwardly extending projections that are adjacent back corners of the antenna housing and that extend longitudinally along at least a portion of a length of the passive antenna thereby providing a wind load reduction.

Embodiments of the present invention are directed to an antenna assembly that includes: a first housing with a rear wall and an external front radome; a second housing with a rear wall and an external radome positioned adjacent the first housing; and a passive inter-modulation distortion (“PIM”) shield that is positioned to extend across at least part of the rear walls of the first and second housings.

The PIM shield can have a frequency selective surface (FSS).

The FSS can be configured to reflect or block electromagnetic waves from radiating elements of a passive base station antenna that operates in one or more lower frequency bands while allowing higher frequency band electromagnetic waves of the active antenna to travel therethrough.

The PIM shield can have a first PIM shield body and a second PIM shield body, each extending longitudinally and having a lateral extent, the first shield PIM body can have a rear wall residing behind the first housing and the second PIM shield body can have a rear wall residing behind the second housing.

The first and second PIM shield bodies can cooperate to define at least one channel configured to slidably receive a mounting bracket assembly.

The PIM shield can have a rear wall with first and second laterally spaced apart and rearwardly extending projections that extend longitudinally along at least a portion of a length of the housing thereby providing a wind load reduction.

The FSS can have a first pattern unit configuration at a first location and a second pattern unit configuration at a second location. The first pattern unit configuration can be different than the second pattern unit configuration.

The PIM shield can have first and second sidewalls that can project forwardly of a rear wall thereof and the first sidewall can be coupled to an outer sidewall of the first housing and the second sidewall can be coupled to an outer sidewall of the second housing.

The first and second sidewalls can be metal and devoid of an FSS.

The first and second sidewalls can have an FSS.

The FSS can be provided, at least in part, by a sheet of metal arranged to provide a grid pattern of unit cells.

The mounting bracket assembly can have a field structure mounting bracket and a primary bracket. The primary bracket can extend laterally behind the first and second housings and the first PIM shield body can be attached to a first end portion of the primary bracket and the second PIM shield body can be attached to a second end portion of the primary bracket and the first and second housings can have a longitudinally extending gap space therebetween.

The first PIM shield body can have an inner facing edge and the second PIM shield body can have an inner facing edge. The inner facing edges can be spaced apart.

The first PIM shield body can have an inner facing edge and the second PIM shield body can have an inner facing edge. One of the inner facing edges can reside behind the other and each can extend behind the gap space.

Yet other embodiments are directed to an antenna system that includes: a first passive antenna having a first housing with a front radome and a rear wall, with a plurality of columns of first radiating elements in the first housing and configured for operating in a first operational frequency band, each column of first radiating elements including a plurality of first radiating elements arranged in a longitudinal direction; a second passive antenna having a second housing with a front radome and a rear wall, with a plurality of columns of first radiating elements in the first housing and configured for operating in a first operational frequency band, each column of first radiating elements including a plurality of first radiating elements arranged in a longitudinal direction; and a passive intermodulation (PIM) shield that includes a frequency selective surface (FSS) extending behind and across the rear wall of the first housing and the rear wall of the second housing for at least part of a length thereof. The FSS is configured to reflect, absorb or block electromagnetic waves within the first operational frequency band and pass electromagnetic waves at a higher frequency band.

The PIM shield can have first and second sidewalls, the first sidewall of the PIM shield extending along an outer facing sidewall of the first housing, the second sidewall of the PIM shield extending along an outer facing sidewall of the second housing.

The first housing and the second housing can have inner facing sidewalls that are spaced apart by a gap space. The PIM shield can extend across the gap space at least for some of a longitudinal dimension of the PIM shield.

The first housing and the second housing can have inner facing sidewalls that can be spaced apart by a gap space. The PIM shield can be configured to not extend across the gap space over at least a major portion of a longitudinal dimension of the PIM shield.

The PIM shield can have a first longitudinally extending body coupled to a second longitudinally extending body.

The PIM shield can have a rear wall with first and second laterally spaced apart and rearwardly extending projections that extend longitudinally along at least a portion of a length of the passive antenna thereby providing a maximum wind load reduction relative to passive antennas without the PIM shield with the first and second laterally spaced apart projections.

Additional embodiments are directed to a retrofit kit for dual antennas that include: a passive intermodulation (PIM) shield sized and configured to extend across rear walls of the dual antennas; and mounting hardware configured to attach the PIM shield to a bracket assembly attached to both of the dual antennas.

The PIM shield of the retrofit kit can be provided as two separate PIM shield bodies. The mounting hardware can include two rail guides or two PIM guard mount components.

The PIM shield can have a length that is at least 50% of a length of the dual antennas. The PIM shield can have a frequency selective surface.

The PIM shield bodies can each have a length that is at least 50% of a length of the dual antennas and the PIM shield bodies can be configured so that one resides behind one of the dual antennas and another one resides behind another one of the dual antennas.

The PIM shield can have lift attachment features that project rearwardly of a rear wall of the PIM shield and that can releasably engage lift cables for field installation.

Further features, advantages and details of the present invention will be appreciated by those of ordinary skill in the art from a reading of the figures and the detailed description of the preferred embodiments that follow, such description being merely illustrative of the present invention. It is noted that aspects of the invention described with respect to one embodiment, may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail in the specification set forth below.

### BRIEF DESCRIPTION OF THE DRAWINGS

FIG. 1 is a partially exploded rear view of an assembly comprising a PIM shield with a dual antenna arrangement according to embodiments of the present invention.

FIG. 2 is an assembled rear view of the assembly of FIG. 1.

FIG. 3 is an enlarged rear, side perspective view of a bottom portion of the assembly shown in FIG. 2.

FIG. 4 is a side view of the assembly shown in FIG. 2.

FIG. 5 is a front view of the assembly shown in FIG. 2.

FIG. 6A is a rear perspective view of a portion of the assembly shown in FIG. 2.

FIG. 6B is a rear view of the portion of the assembly shown in FIG. 6A.

FIG. 6C is a greatly enlarged rear view of a portion of an antenna with a PIM shield coupling member prior to assembly to the antenna according to embodiments of the present invention.

FIG. 6D is an assembled view of the components shown in FIG. 6C.

FIG. 6E is a greatly enlarged assembled view of a portion of the components shown in FIG. 6D.

FIG. 6F is an enlarged rear perspective view of a preinstallation position of a portion of a PIM shield body aligned with the assembled components shown in FIG. 6D according to embodiments of the present invention.

FIG. 6G is an enlarged rear perspective view of an installed position of the portion of the PIM shield body and coupling member shown in FIG. 6F.

FIG. 7A is a rear assembled view of the assembly, similar to that shown in FIG. 2, but illustrating an alternative window configuration according to embodiments of the present invention.

FIG. 7B is an enlarged rear, side perspective view of a bottom portion of the assembly, similar to that shown in FIG. 3 but with the PIM shield comprising an inner wall that extends in a front to back direction, longitudinally along at least part of the PIM shield according to embodiments of the present invention.

FIG. 8 is a partially exploded rear view of another embodiment of an assembly comprising a PIM shield with a dual antenna arrangement according to embodiments of the present invention.

FIG. 9 is an assembled rear view of the assembly of FIG. 8.

FIG. 10 is an enlarged, rear perspective view of a bottom portion of the assembly shown in FIG. 9.

FIG. 11 is a rear perspective, partially exploded view of the bottom portion of the assembly shown in FIG. 10.

FIG. 12 is a rear perspective, partially exploded view of the bottom portion of the assembly shown in FIG. 10.

FIG. 13 is a rear, side perspective assembled view of the assembly shown in FIG. 12.

FIG. 14 is a rear perspective view of a rail guide that slidably couples to the PIM cover and mounting bracket shown in the assembly of FIG. 13.

FIG. 15 is a rear perspective view of a portion of the cover of the PIM shield configured to couple to the rail guide shown in FIG. 14.

FIG. 16A is an enlarged rear perspective view of a portion of the rear of the assembly shown in FIG. 10 with a bracket coupled to the rail guide with a bracket mount and the rail guide coupled to the cover of the PIM shield.

FIG. 16B is a side perspective view of the bracket mount shown in FIG. 16A.

FIG. 17 is an end view of a PIM shield that can be used to partially enclose side-by side dual antenna, leaving the front radomes thereof exposed, according to embodiments of the present invention.

FIG. 18 is a greatly enlarged view section view of a portion of a multi-layer PIM shield with an FSS according to embodiments of the present invention.

FIG. 19A is a front view of an example pattern unit cell array/grid of an FSS according to embodiments of the present invention.

FIG. 19B is a schematic illustration of a PIM shield having different FSS configurations in different regions according to embodiments of the present invention.

FIG. 19C is a back view of an example PIM shield with an FSS according to embodiments of the present invention.

FIG. 19D is a back, side perspective view of one part of the PIM shield shown in FIG. 19C illustrating the sidewall can also have an FSS according to embodiments of the present invention.

FIG. 20A is a schematic illustration of a PIM shield and dual antenna assembly mounted to a field mounting structure, shown as a pole, in front of an example active antenna module/unit according to embodiments of the present invention.

FIG. 20B is a schematic illustration of a PIM shield and dual antenna assembly mounted to a field mounting structure, shown as a pole, adjacent two spaced apart active antenna modules/units according to embodiments of the present invention.

FIG. 21A is a front view of an example passive antenna assembly that may be provided in one of the antennas shown in FIGS. 1, 8, for example, according to embodiments of the present invention.

FIG. 21B is a side view of the example passive antenna assembly shown in FIG. 21A.

FIGS. 22A and 22B are schematic illustrations of field retrofit kits comprising PIM shields and mounting hardware according to embodiments of the present invention.

### DETAILED DESCRIPTION

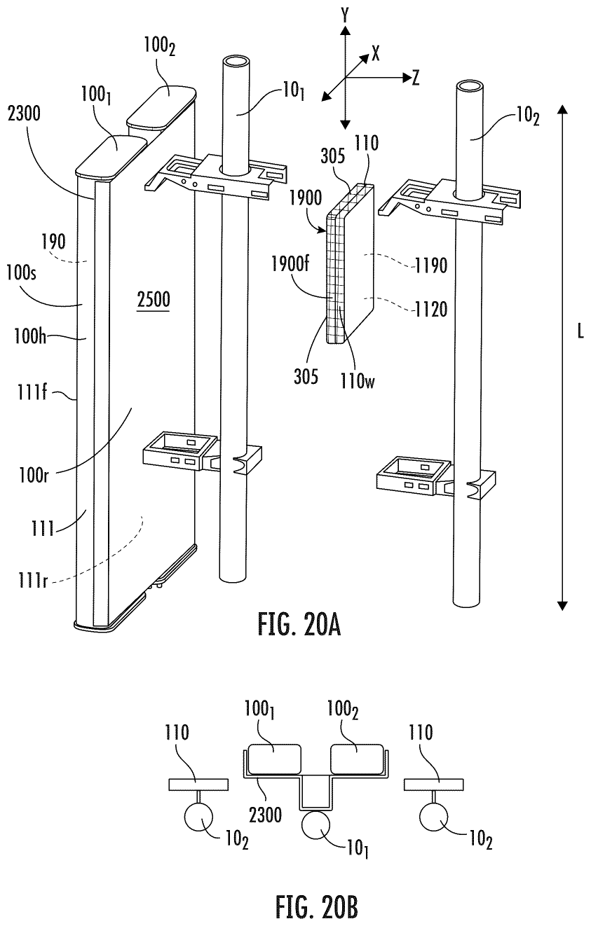

Embodiments of the present invention are directed to antennas. These antennas may be provided as base station antennas. The description that follows assumes that the antennas can be mounted for use on a tower, pole, roof, wall or other mounting structure 10₁, 10₂ (FIGS. 20A, 20B) with the longitudinal axis L (FIG. 20A) of the antenna extending along a vertical (Y) axis and the front of the antenna mounted opposite the tower, pole or other field mounting structure pointing toward the target coverage area for the base station antenna. It will be appreciated that the (base station) antennas may not always be mounted so that the longitudinal axes thereof extend along a vertical axis. For example, the (base station) antennas may be tilted slightly (e.g., less than) 10° with respect to the vertical axis so that the resultant antenna beams formed by the base station antennas each have a small mechanical downtilt.

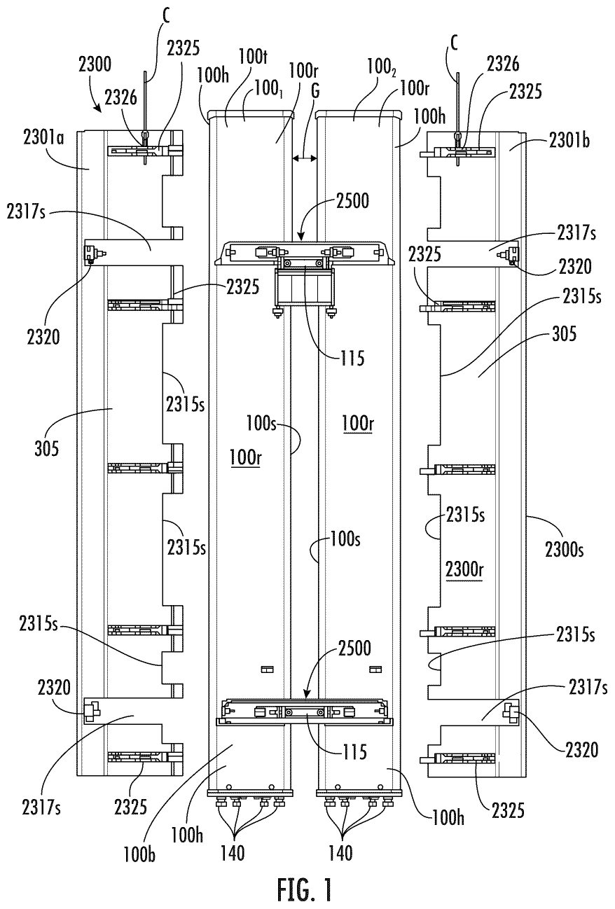

Turning to FIGS. 1-5, a PIM shield 2300 is shown coupled to a pair of side-by-side, first and second antennas 100₁, 100₂ forming a PIM shield and antenna assembly 2400. Each antenna 100₁, 100₂ can be a passive antenna of a base station antenna. The antennas 100₁, 100₂ can be enclosed in a respective (passive) antenna housing 100h that may be substantially rectangular with a rectangular cross-section. At least a front 100f of the housing 100h may be implemented as a radome 111. A radome refers to a dielectric cover that allows RF energy to pass through in certain frequency bands. A rear 100r of the housing 100h may also include a radome that is a rear radome 111r that is opposite, in a front to back direction, the front side radome 111f. As shown, the housing 100h can have two (narrow) sidewalls 100s, facing each other and extending rearwardly between the front radome 111f and the rear radome 111r. The sidewalls 100s can comprise a radome material. The sidewalls 100s can have a width, measured in a front-to-back direction, that is 40%-90% less than a lateral extent of the housing 100h. The radome 111 may be formed of, for example, fiberglass or plastic. The rear radome 111r may be formed of a different material or thickness than the front radome 111f.

At least one laterally extending bracket assembly 2500 comprising a field mounting bracket 115 can be attached to each of the first and second antennas 100₁, 100₂. As shown the at least one bracket assembly 2500 can be provided as two bracket assemblies, one closer to the top portion 100t of the housing 100h and one closer to the bottom portion 100b of the housing 100h. The antennas 100₁, 100₂ can be held by the at least one bracket assembly 2500 so that there is a small gap space “G” between inner facing side walls 100s of the two antennas 100₁, 100₂ and the bracket assembly 2500 extends across this gap space G. The spacing of the gap G can be in a range of about 0.5 inches to about 5 inches or more. The gap G can be, for example in a range of 2-4 inches such as about 3.6 inches, in some embodiments.

One sidewall 2300s of the PIM shield 2300 is adjacent an outwardly facing sidewall 100s of the first antenna 100₁ and the other sidewall 2300s of the PIM shield 2300 is adjacent an outwardly facing sidewall 100s of the second antenna 100₂.

In some embodiments, the sidewalls 2300s of the PIM shield 2300 terminate behind the front 100f of the housing 100h, e.g., behind the front radome 111f. In other embodiments, the sidewalls 2300s of the PIM shield 2300 terminate to be flush with the front radome 111f. In other embodiments, the sidewalls 2300s of the PIM shield 2300 extend forward of the front radome 111f.

In some embodiments, one or both of the antennas 100₁, 100₂ can reside adjacent to, couple to or include at least one active antenna 110 (FIGS. 20A, 20B). The term “active antenna” is used interchangeably with “active antenna unit” and “AAU” and refers to a cellular communications unit comprising radio circuitry and associated radiating elements. The radio circuitry is capable of electronically adjusting the amplitude and/or phase of the subcomponents of an RF signal that are output to different radiating elements of an array of radiating elements or groups thereof. The active antenna 110 may include both the radio circuitry and a radiating element array (e.g., a multi-input-multi-output (mMIMO) beamforming antenna array) and may include other components such as filters, a calibration network, an antenna interface signal group (AISG) controller and the like. The active antenna 110 can be provided as a single integrated unit or provided as a plurality of stackable units, including, for example, first and second sub-units such as a radio sub-unit (box) with the radio circuitry and an antenna sub-unit (box) with a multi-column array of radiating elements and the first and second sub-units stackably attach together in a Z (front to back) direction, with the radiating element array closer to the radome 119 of the AAU than the radio circuitry 1120 (FIG. 20A). The active antenna 110 may operate as a stand-alone unit that is mounted on an antenna tower or may be included as part of the (passive) antenna 100.

In certain situations, RF energy emitted by the arrays of radiating elements in one antenna 100₁ may impinge on the other antenna 100₂ and vice versa and/or RF energy emitted by an AAU 110 may impinge one or both of the antenna 100₁, 100₂ or other equipment in the area and may form currents on metal structures one or more antennas 100. If these currents flow through inconsistent metal-to-metal connections or other PIM generating elements, then intermodulation products may arise. These intermodulation products may radiate in various directions and portions of these PIM signals may be received within the passive antenna assembly where they may appear as PIM distortion. This PIM distortion may, in some cases, severely degrade the performance of the antenna 100.

Active antennas such as active antenna 110 (FIGS. 20A, 20B) are often configured to operate using time division duplexing multiple access schemes in which the transmit and receive signals do not overlap in time, but instead the active antenna transmits RF signals during selected time slots and receives RF signals during other time slots. As a result, the amount of PIM that can be tolerated by an active antenna 110 may be much higher than the PIM levels that are acceptable for antennas such as passive antenna assemblies that operate under frequency division duplexing (FDD) multiple access schemes. In such FDD systems, the PIM signal(s) can be as large as signals being received by the low band and/or mid band radiating elements.

A PIM shield 2300 can ameliorate or reduce the severity of PIM issues in “noisy” RF environments. Referring again to FIGS. 1-5, in certain embodiments, the PIM shield 2300 can be positioned on and/or partially about the first and second antennas 100₁, 100₂ with the rear 2300r of the PIM shield 2300 extending across and covering the rear wall 100r of each of the first and second antennas 100₁, 100₂.

For field retrofit to add a PIM shield 2300 to the dual, side-by-side antennas 100₁, 100₂, due to the tight lateral spacing between the two antennas providing a small gap space “G” when coupled to the field mounting structure 10₁ (FIGS. 20A, 20B) behind the antennas 100₁, 100₂, it may be helpful to provide the PIM shield 2300 as first and second body segments 2301a, 2301b. These first and second body segments 2301a, 2301b can be provided separately and lifted into position separately or concurrently, one on one outer side of the first antenna 100₁ and one on the outer side of the second antenna 100₂ and slid laterally inward toward each other into operative position. Although the PIM shield 2300 is shown as two having two body segments, more than two body segments can be used or even a single unitary body may be used in some embodiments.

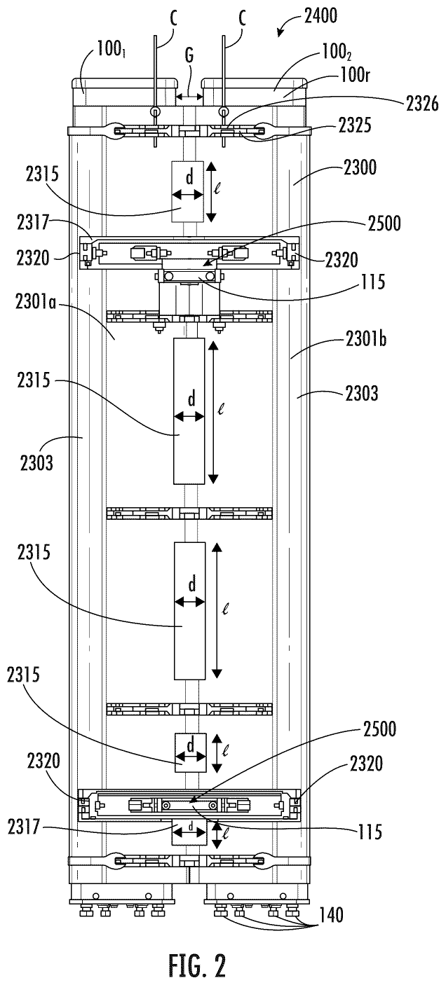

Referring to FIG. 2, the PIM shield 2300 can comprise a plurality of windows 2315 that can be longitudinally spaced apart. The PIM shield 2300 can comprise at least one bracket receiving channel 2317 sized and configured to extend about a bracket assembly 2500. The windows 2315 can reduce weight and/or provide a wind path to reduce (frontal) wind load.

The windows 2315 can have different lengths “I” and different widths “d”. The windows 2315 can have the same lengths “I” and the same widths “d”. The windows 2315 can have the same width “d” and different lengths “I”. The windows 2315 can have the same lengths “I” and different widths “d”.

As shown, the windows 2315 are arranged with some with longer lengths in medial locations and some with shorter lengths “I” closer to the top and bottom locations. The window 2315 with the shortest length “I” can be at a bottom portion of the PIM shield 2300. The widths “d” can be equal to, less than, or greater than the width of the gap space G.

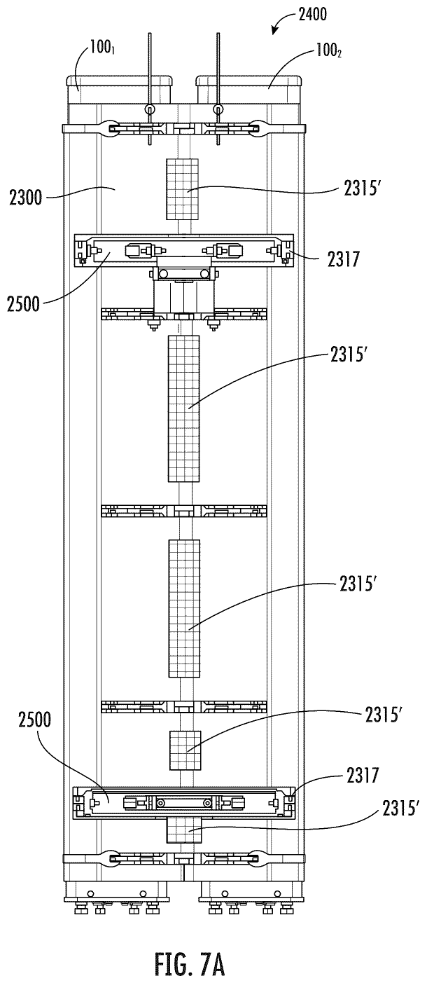

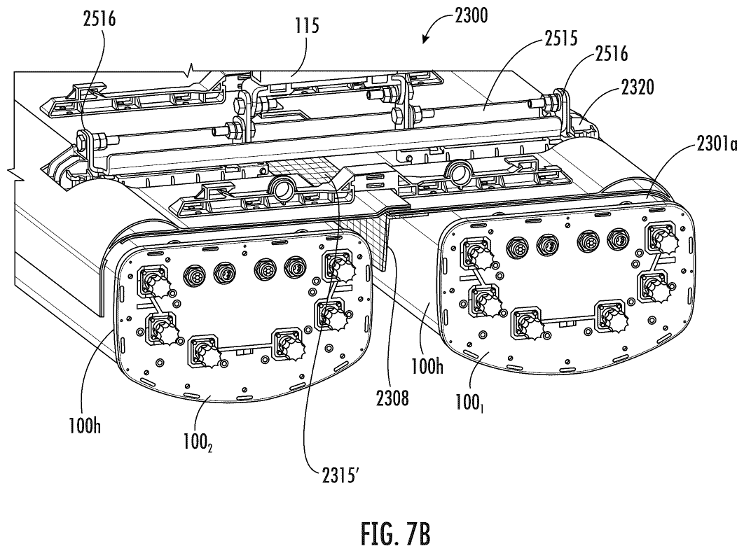

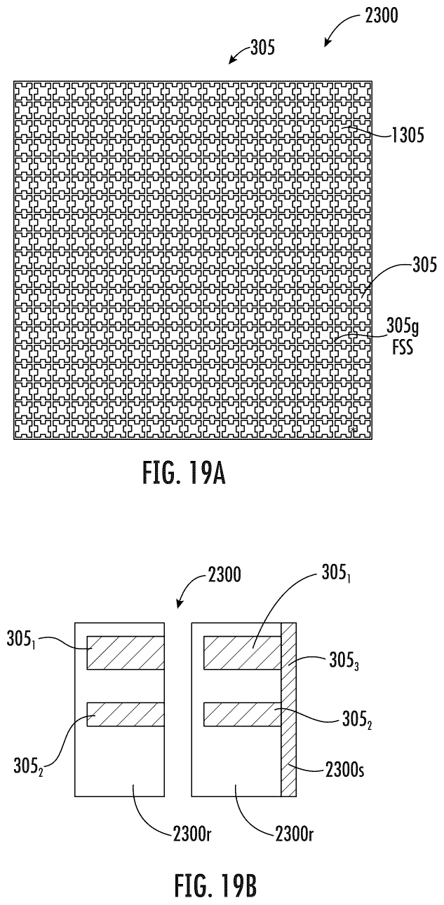

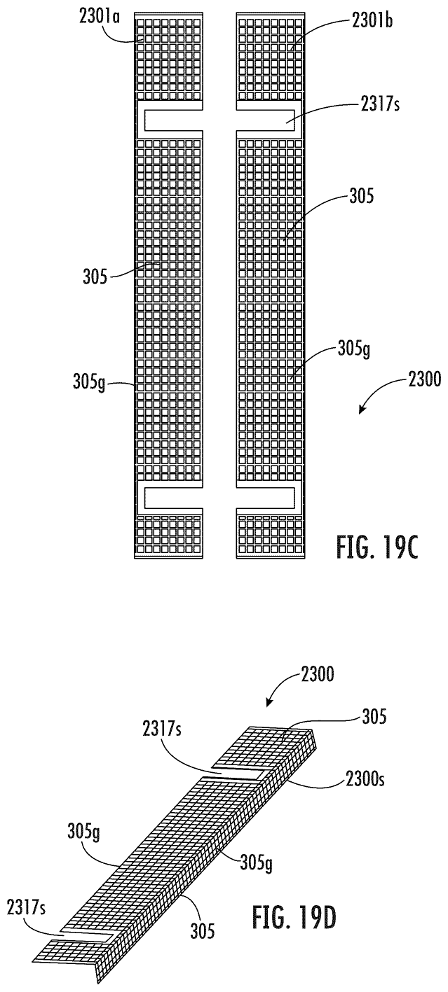

The windows 2315 can be totally open as shown or the windows 2315′ provided as a mesh or patterned aperture shape(s) (FIG. 7A). For the embodiment shown in FIG. 7A, the patterned shape(s) can provide increased structural support. Alternatively, or additionally, the patterned shape(s) provided by the window 2315′ can be a grid pattern 305g of unit cells (FIG. 19A) configured to provide a frequency selective surface (FSS) that can allow RF signal in some ranges to pass and that can block other ranges.

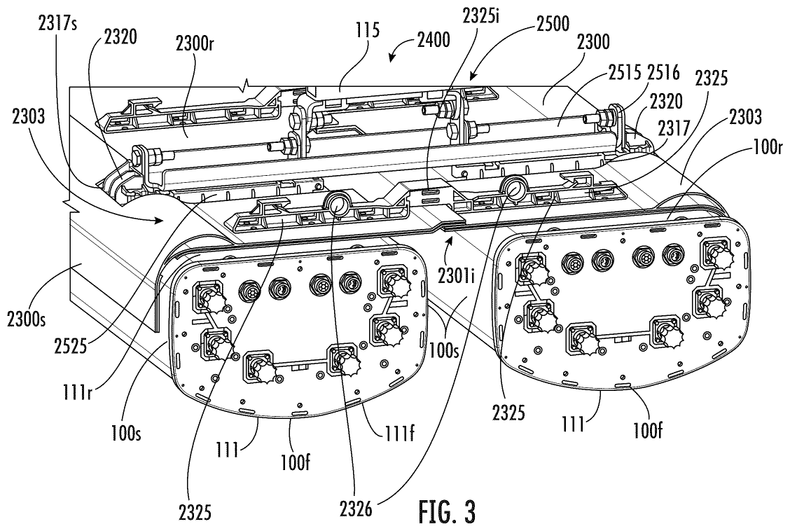

FIG. 7B illustrates a PIM shield 2300 similar to that shown in FIG. 3 but with the PIM shield 2300 comprising at least one inner wall or inner partition 2308 that extends in a front-to-back direction about at least part of a sidewall 100s or between the inner sidewalls 100s of the first and second antennas 100₁, 100₂, longitudinally along at least part of the housing 100h of one or both of the antennas 100₁, 100₂. This wall or partition 2308 can be solid metal, a dielectric, or comprise a frequency selective surface (FSS) or may be provided as a combination of these features. To install to antenna systems at an existing field site, the PIM shield 2301a with the wall 2308 can be lifted, then slid laterally inward between the rear of the housing 100h and a field mounting structure (e.g., pole) 10₁ (FIG. 20A), then moved forward to position the wall 2308 closer to one of the housings 100h, or centrally between the housings 100h. The PIM shield 2300 can have no inner wall 2308, a single such wall 2308 or two walls 2308, one positioned closer to a neighboring sidewall 100s of a respective housing 100h of the first and second antennas 100₁, 100₂.

Referring again to FIGS. 1-5, the PIM shield 2300 can have at least two bracket receiving channels 2317 sized and configured to receive the bracket assembly 2500 with the field mounting bracket 115, one at a top portion and one at a bottom portion of the PIM shield 2300.

Still referring to FIGS. 1-5, the first and second body segments 2301a, 2301b can have a pair of aligned window channel segments 2315s forming a respective corresponding window 2315 and can also have a pair of aligned bracket-receiving channel segments 2317s forming the corresponding bracket receiving channel 2317.

Referring to FIGS. 1-3, 6A and 6B, each bracket receiving channel segment 2317s can have an outer end with an attachment member 2320 that projects outward, in a rearward direction, that is configured to attach to one end of the bracket assembly 2500 to hold the PIM shield 2300 behind the rear of the antennas 100₁, 100₂.

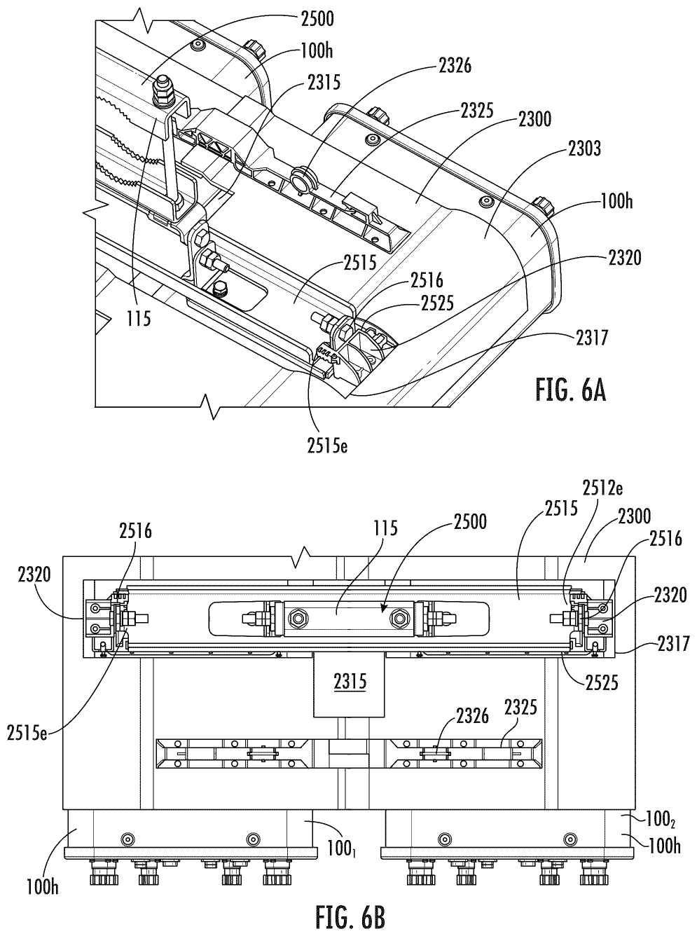

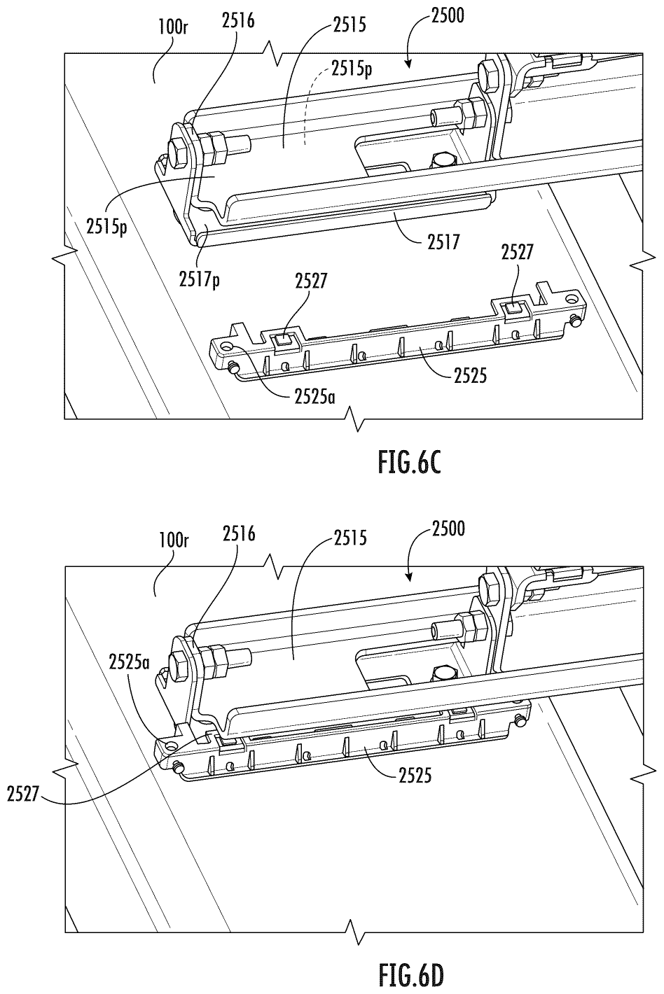

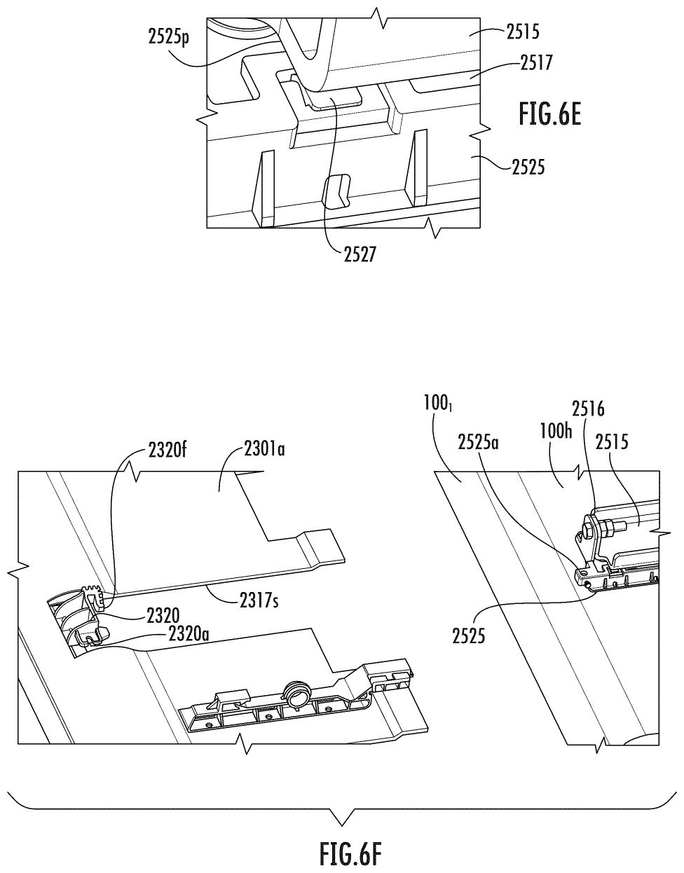

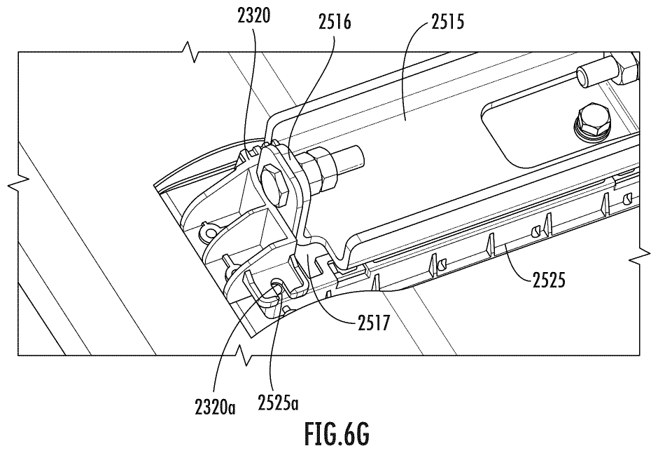

Referring to FIGS. 3, 6A, 6B, the bracket assembly 2500 can comprise a primary bracket 2515 that extends laterally and attaches to a rear 100r of each housing 100h of the first and second antennas 100₁, 100₂. The field structure mounting bracket 115 can be attached to the primary bracket 2515 and can project rearward thereof. The primary bracket 2515 can have outer ends 2515e with projections 2516 that couple to corresponding attachment members 2320 of the PIM shield 2300. The bracket assembly 2500 can extend rearward of the rear 100r of the housing 100h and the PIM shield 2300.

Turning now to FIGS. 6C-6G, PIM shield coupling members 2525 can be assembled to the bracket assembly 2500 while the bracket assembly 2500 is in position on the rear 100r of the antenna according to embodiments of the present invention. Each coupling member 2525 can have spring loaded fingers 2527 and fastener apertures 2525a. The primary bracket 2515 of the bracket assembly 2500 can be held by cradles 2517 on each end that are directly mounted to the rear 100r of a respective housing 100h. The coupling members 2525 can be positioned so that the fingers 2527 extend between the cradle 2517 and the primary bracket 2515. That is, the cradle 2517 can have a primary surface 2517p that faces outward and extends laterally and the primary bracket 2515 can have a primary surface 2515p that faces inward and extends laterally a greater lateral distance than the cradle 2517 as there are two cradles 2517, one attached to each antenna 100₁, 100₂ and both attached to the primary bracket 2515. The fingers 2527 of the PIM shield coupling member 2525 can be substantially parallel to the rear of the housing 100h and can be positioned between these primary surfaces 2517p, 2515p and can frictionally couple thereto.

FIG. 6F illustrates a preinstallation position of a portion of a PIM shield body 2301 aligned with the PIM shield coupling member 2525 assembled to the bracket assembly 2500 of the antenna 100₁ with the channel segment 2317s aligned to slidably receive the primary bracket 2515 and PIM shield coupling member 2525. The attachment member 2320 can have fastener apertures 2320a and may include a finger 2320f that can flex laterally to position the projecting member 2516 between the finger 2320f and the support body 2320b. The fastener apertures 2525a, 2320a can be aligned and a fastener inserted to secure the components. FIG. 6G is an enlarged rear perspective view of an installed position of the portion of the PIM shield body and coupling member shown in FIG. 6F.

The first and second PIM bodies 2301a, 2301b can have a plurality of laterally extending support features 2325. In some embodiments, aligned pairs of the laterally extending support features 2325 on the first and second bodies 2301a, 2301b can be attached together. Top, and optionally bottom, sets of the laterally extending support features 2325 can have lift engagement members 2326 that can project rearward to provide case of access and releasably engage lift cables C (FIG. 1, for example).

Referring to FIG. 3, at least some of the laterally extending support features 2325 can be attached at inner facing end portions 2325i to interlock the first and second PIM bodies 2301a, 2301b. As shown, the first and second PIM bodies 2301a, 2301b can be configured to have some inner end portions 2301i that overlap each other, one in back of the other.

As shown in FIGS. 1-6A and 17, for example, the PIM shield 2300 can have first and second curvilinear projections 2303 that are laterally spaced apart across a width dimension, one adjacent each right and left side back corner location, that project rearward from a rear 100r of each of the first and second antenna housings 100h and that can extend longitudinally along at least 50% of a length of the base station antenna housing 100h. The curvilinear projections 2303 can be arcuate as shown. The curvilinear projections 2303 can be configured to reduce a maximum (frontal) wind load relative to a base station antenna housing 100h without a PIM shield 2300 comprising the projections 2303.

Referring to FIGS. 3, 6 and 17, the PIM shield 2300 can be configured with an open-front of a U-shape with the closed end of the U being the rear 2300r of the PIM shield 2300 and configured to be rearward of the rear 100r of both of the housings 100h of the first and second antennas 100₁, 100₂. The U-shape typically has a lateral dimension/width that is greater than a lateral cumulative extent of the housings 100h and greater a length of the outer arms/sides of the “U” to form a “short” or compressed U-shape.

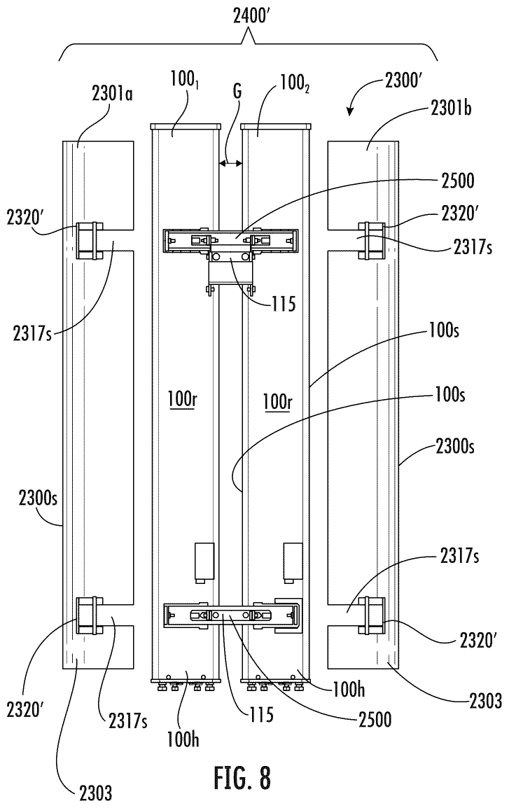

Referring now to FIGS. 8-16B, another embodiment of the PIM shield 2300′ is shown. As shown, in this embodiment, the first and second PIM bodies 2301a, 2301b have inner edges 2301i that terminate adjacent the inner facing sidewalls 100s of each antenna so as to not laterally overlay at least some of the gap “G” of the first and second antennas 100₁, 100₂, leaving an open space S that extends laterally between the first and second antennas 100₁, 100₂ along at least a major portion (50% or more) of the length dimension of the PIM shield 2300. The open space S can have a lateral dimension that is the same as G or can be less than the gap space G.

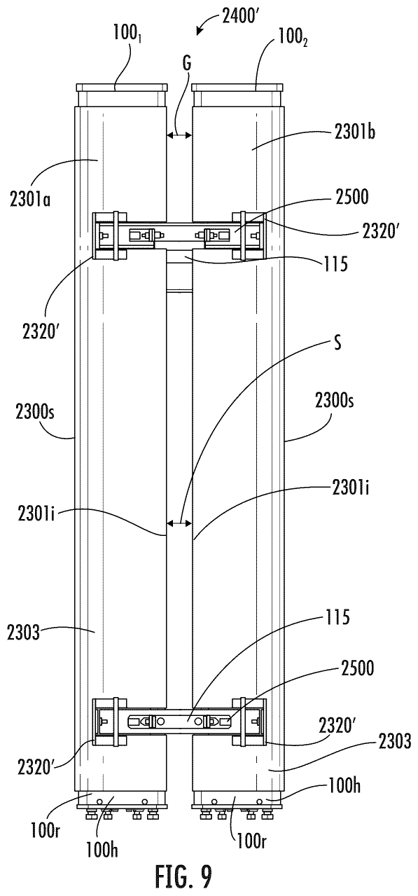

It is contemplated that in certain embodiments, the PIM shield 2300 can comprise combinations of windows 2315, 2315′ (FIGS. 1, 7A) and open spaces S (FIG. 9).

The first and second PIM bodies 2301a, 2301b can comprise the bracket receiving channel segments 2317s forming the channel 2317 as discussed above with respect to FIGS. 1-5.

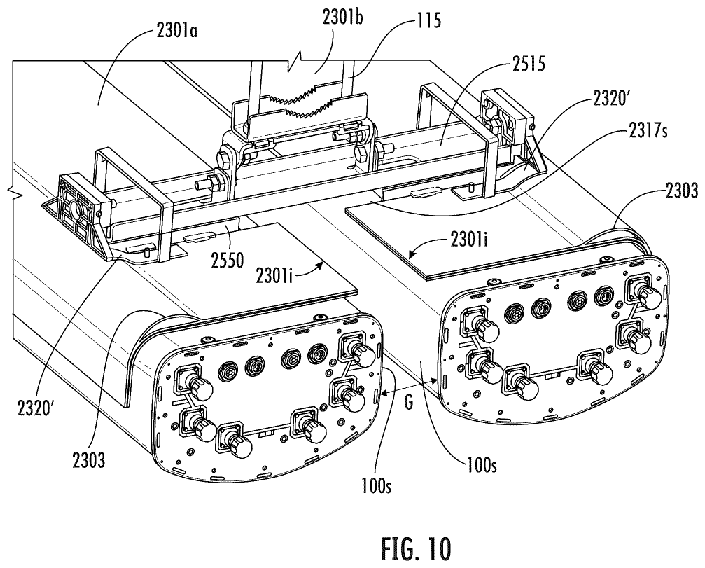

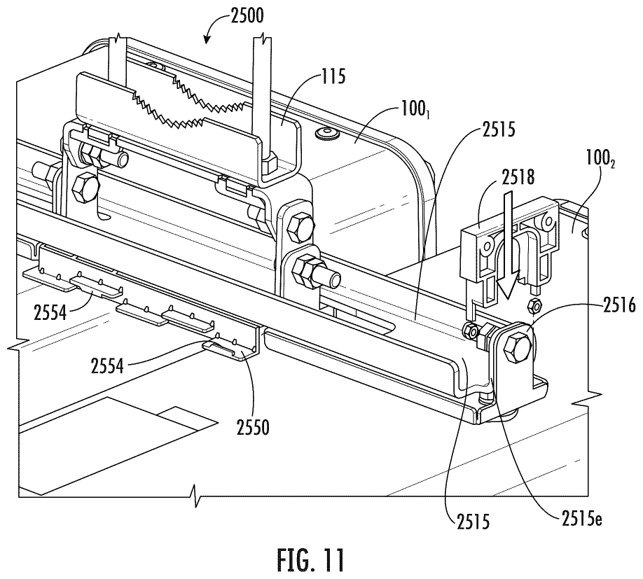

In certain embodiments, the first and second PIM bodies 2301a, 2301b do not interlock with each other but can separately attach to the bracket assembly 2500. Referring to FIGS. 10 and 11, the bracket assembly 2500 can engage first and second rail guides 2550 that slidably receive the corresponding first and second PIM body 2301a, 2301b. The rail guides 2550 can be coupled to a preinstalled bracket assembly 2500 by sliding each rail guide 2550 under and onto outer end portions of the primary bracket 2515 in front of the respective rear wall 100r of the housing 100h of each of the first and second antennas 100₁, 100₂. The rail guides 2550 can frictionally engage the primary bracket 2515.

Referring to FIGS. 10-16B, a bracket mount 2518 with an inwardly projecting leg 2519 can be slid forward to engage a locking feature 2551 in the rail guide 2550. The locking feature 2551 is shown in FIG. 14 as an aperture in an car 2552 that extends inwardly toward a laterally extending open channel 2553 of the rail guide 2550. The forwardmost surface 2550f of the rail guide 2550 can abut the rear wall 100r of the corresponding antenna. A rearwardmost surface 2550r can project rearward from a wall segment 2550w that is perpendicular to the forwardmost surface 2550f.

As shown in FIG. 15, the first and second PIM shield bodies 2301a, 2301b can comprise attachment apertures 2302 that can be elongate in a lateral dimension and can be positioned adjacent the top and bottom edges of each bracket receiving channel segment 2317s.

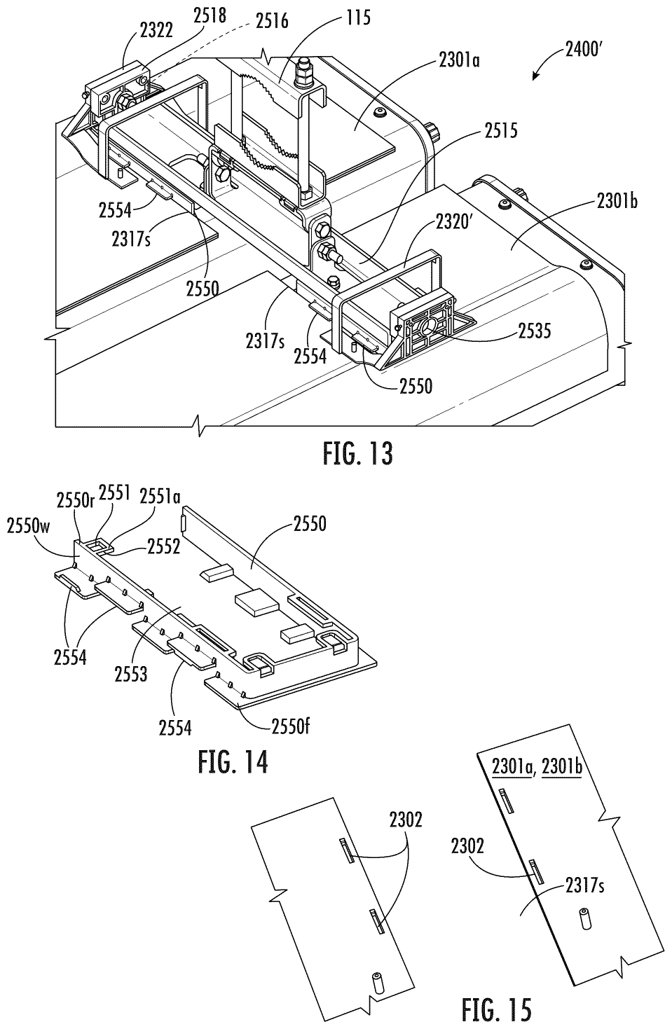

As shown in FIGS. 13 and 14, for example, the rail guide 2550 can comprise tabs 2554 sized and configured to extend through the apertures 2302 to couple the PIM body 2301a, 2301b to the bracket assembly 2500, and therefore to the antennas 100₁, 100₂. The tabs 2554 can be arranged in different planes with some projecting outwardly and some projecting inwardly so that some extend in front of a respective PIM shield body 2310a, 2301b, and some behind the respective PIM shield body 2301a, 2301b.

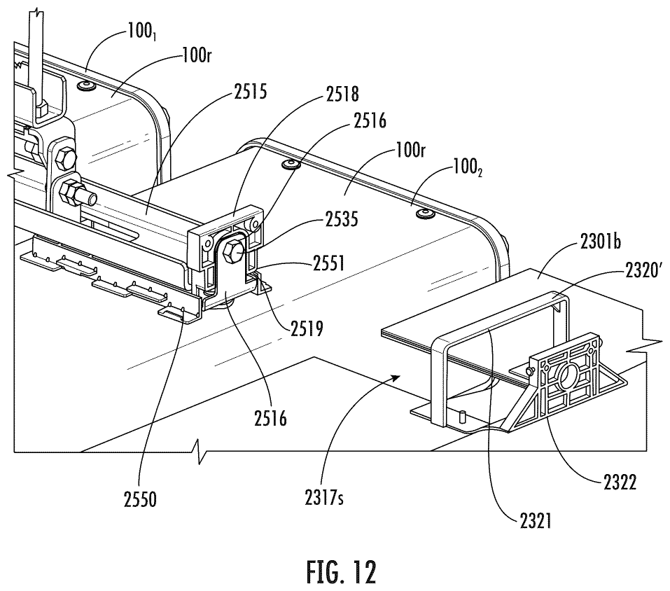

The primary bracket 2515 can have outer ends 2515e with projections 2516 that couple to corresponding attachment members 2320′ of the PIM shield 2300. Referring to FIGS. 12, 13 and 16A, the attachment members 2320′ provided by the first and second PIM shield bodies 2301a, 2301b can have a bridge member 2321 that extends behind and over the primary bracket 2515 and a shorter attachment projection 2322. The bridge member 2321 can increase structural rigidity but is not required.

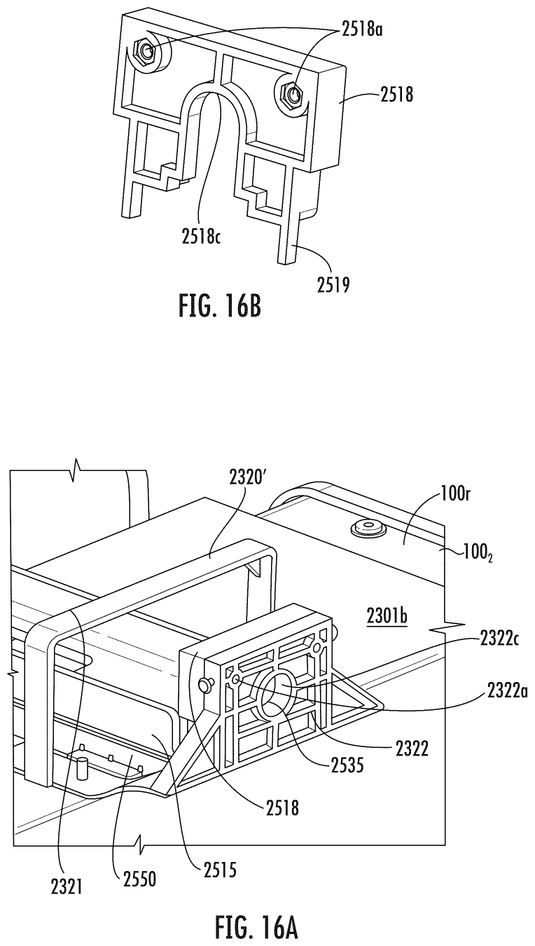

The attachment projection 2322 can be attached to the primary bracket projection 2516 and the bracket mount 2518 that couples to the rail guide 2525. The primary bracket projection 2516 can be sandwiched between the bracket mount 2518 and the PIM shield attachment projection member 2322. The bracket mount 2518 can be a molded mount and can have attachment apertures 2518a (FIG. 16B) that may have threads formed therein or provided by nuts held in the bracket mount body that can align with fasteners apertures 2322a (FIG. 16A) to secure the components. The bracket mount 2518 can have a channel 2518c (FIG. 16B) sized and configured to receive at least a portion of the primary bracket projection 2516 (FIG. 13).

The PIM shield 2300 can be provided as a metal PIM shield 2300. The PIM shield 2300 can comprise a frequency selective surface (FSS) 305. The PIM shield 2300 can comprise metal, such as aluminum, and a FSS 305.

Where used by a PIM shield 2300, the FSS 305 can be provided in a number of ways. See, co-pending PCT/US2024/018294, filed Mar. 4, 2024, the contents of which are incorporated by reference as if recited in full herein.

The FSS 305 may be configured to reflect and/or absorb RF signals within the operating frequency bands of nearby antennas 100 which may be antennas comprise passive antenna assemblies. The FSS 305 can be configured to pass RF signals within the operating frequency band of an active antenna 110.

For example, the FSS 305 of the PIM shield 2300 may be configured to pass RF signals in some or all of a high-band frequency range (e.g., the 3.1-5.8 GHz frequency range) while reflecting and/pr absorbing RF signals in the above-described low-band and mid-band frequency ranges.

The FSS 305 can extend across and along the rear wall 2300r and along and across the sidewalls 2300s of the PIM shield 2300. The sidewalls 2300s of the PIM shield 2300 can be sized and configured to extend forward to cover at least a portion of the sidewalls 100s of the base station antennas 100₁, 100₂ (FIGS. 3, 4, 6A, 10).

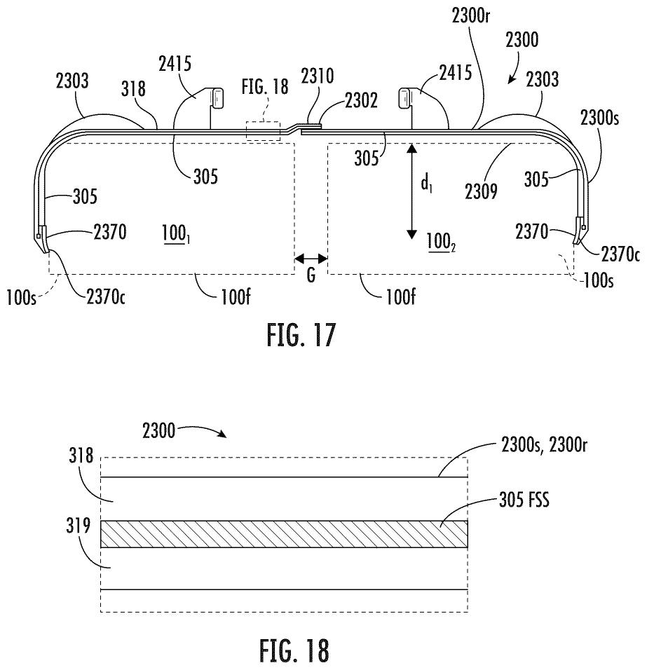

Referring to FIG. 17, the PIM shield 2300 can have side attachment features 2370 that are sized and configured to couple to the sidewalls 100s of the base station antenna housing 100h. The side attachment features 2370 can be configured to have gripping connectors 2370c that frictionally engage sidewalls 100s of the base station antenna 100.

Referring to FIGS. 17 and 18, the PIM shield 2300 can be provided as a multi-layer structure with the FSS 305 positioned between a first layer 318 and a second layer 319. The first layer 318 and the second layer 319 can provide a solid external surface protecting the FSS 305 and/or that provides an aesthetic cover layer(s). The first and second layers 318, 319 can be provided as a thin plastic suitable for radomes to cover both the inside surface and the outside surface of shield 2300. The middle layer 305 can be provided as a metal grid, optionally made of sheet metal. However, the metal pattern provided by the middle layer 305 can also be printed or laminated onto at least one of the primary surfaces of at least one of the (plastic) layers 318, 319, but configured so that the metal pattern—back or front—of the PIM shield 2300 is internal and thus not externally exposed.

The PIM shield 2300 can be thin and structurally semi-flexible with sufficiently rigid to be able to maintain its three-dimensional shape when unassembled but able to attach to the (base station) antenna housings 100h. The FSS 305 can be patterned onto a PIM shield outer surface or provided as an internal layer of a multi-layer shield. For example, a flexible film or flexible printed circuit board with a pattern of unit cells/grid can be adhesively attached to one or more surfaces of the PIM shield 2300.

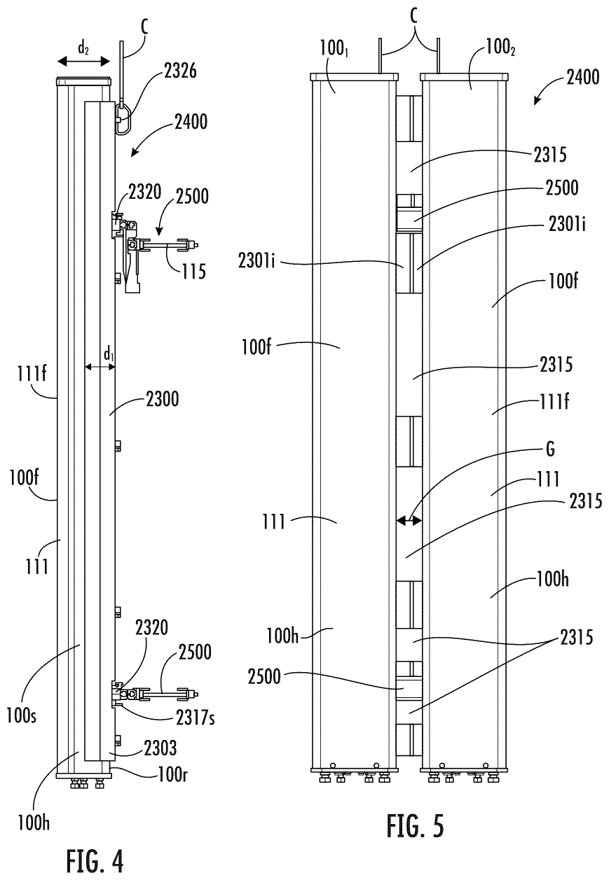

Referring to FIGS. 4 and 17, the PIM shield 2300 can define a cavity 2309 that has a depth “d₁” that is sized and configured to receive a portion of the housing 100h of both of the first and second antennas 100₁, 100₂, in a front to back direction of the antenna housing 100h, typically in a range of 10%-90% of a Z dimension “d₂” of the base station antenna housing 100h shown as about 50% in FIG. 4.

The PIM shield 2300 can include different patterns of FSS 305 along its length and/or across its width and/or along or across sidewalls 2300s thereof.

Referring to FIG. 19A, a grid pattern 305g can be provided by a sheet(s) of metal, metal patches or metallized pattern on a non-metallic substrate and/or a printed circuit board, and can be configured to provide with an array of unit cells 1305 having shaped metal patches that are configured to allow high band radiating elements to propagate electromagnetic waves and reflect/absorb low band signal from low band radiating elements projecting forward of the grid pattern 305g.

In some embodiments, at least part of a PIM shield 2300 can comprise an FSS 305 provided as a single layer of sheet metal providing the grid pattern 305g with the unit cells and with the open centers or interiors devoid of metal. For further discussion of metal grids, see co-pending U.S. application Ser. No. 17/787,619, the contents of which are hereby incorporated by reference as if recited in full herein.

Referring to FIG. 19B, the PIM shield 2300 can have different FSS regions 3051, 3052, 3053, each with pattern unit configurations such that vary and may be configured to block or reflect at different frequency bands. For example, the sidewalls 2300s have a FSS configuration that is different from the rear wall 2300r. The top portion of the rear wall 2300r can have a different FSS configuration than a medial or bottom portion of the rear wall 2300r.

FIGS. 19C and 19D show an example PIM shield 2300 with an FSS 305 comprising a grid 305g according to embodiments of the present invention. FIG. 19D illustrates that the sidewall 2300s of the PIM shield 2300 can also have an FSS 305 according to embodiments of the present invention. The sidewall 2300s can have the same or different grid pattern 305g as the primary rear wall of the PIM shield 2300.

The FSS 305 can be configured to allow high band radiating elements 1190 located in the active antenna 110 (FIG. 20A, 20B) to propagate electromagnetic waves therethrough and to reflect, block or absorb lower band RF signals (lower band electromagnetic waves).

The FSS 305 can be provided, for example, by a printed circuit board or a flexible printed circuit board defining a metal grid pattern of unit cell structures, metallized film or tape having an FSS pattern thereon, a sheet of metal provided with a grid pattern or a radome with a metal grid pattern printed thereon to provide a metallized grid or a non-metallic substrate comprising a metallized surface in a grid pattern.

A discussion of some example FSS' can be found in Ben A. Munk, Frequency Selective Surfaces: Theory and Design, ISBN: 978-0-471-37047-5; DOI: 10.1002/0471723770; April 2000, Copyright © 2000 John Wiley & Sons. Inc., the contents of which are hereby incorporated by reference as if recited in full herein. See also, co-pending U.S. patent application Ser. No. 17/468,783, the contents of which are also incorporated by reference as if recited in full herein.

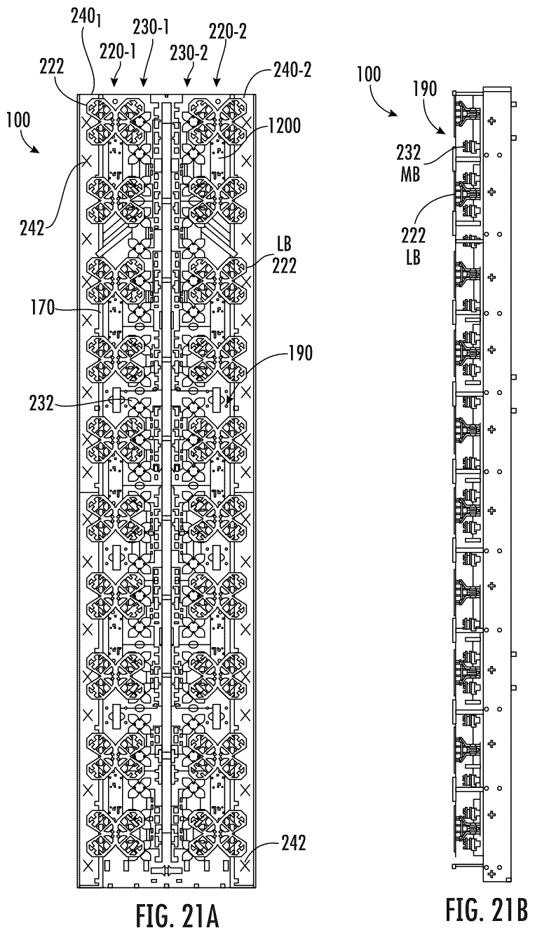

The FSS 305 can comprise, in some embodiments, metamaterial, a suitable RF material or even air (although air may require a more complex assembly). The term “metamaterial” refers to composite electromagnetic (EM) materials. Metamaterials may comprise sub-wavelength periodic microstructures. The FSS 305 may be configured to reduce or prevent low-band and mid-band RF energy emitted by the passive antenna assembly 190 (FIGS. 21A, 21B) from impinging on the active antenna 110 (FIGS. 20A, 20B), since the FSS 305 is positioned between the passive antenna assembly 190 and the active antenna 110 and acts to reflect and/or absorb the low-band and mid-band RF energy emitted by the passive antenna assembly 190. Since much or all of the low-band and mid-band RF energy emitted by the passive antenna assembly 190 will not impinge on the active antenna 110, the generation of PIM distortion by surfaces on the active antenna 110 may be reduced or prevented. Moreover, the FSS 305 may be designed to be a relatively PIM-free structure that will not generate intermodulation products in response to low-band and mid-band RF energy emitted by the passive antenna assembly 190. Thus, the FSS 305 may significantly reduce the amount of PIM distortion generated in response to low-band and mid-band RF energy emitted by the passive antenna assembly 190.

The FSS 305 can be configured to allow RF energy (electromagnetic waves) to pass through at one or more first defined frequency range and that is configured to reflect and/or absorb RF energy at a different second frequency band. Thus, the FSS 305 can reside behind at least some antenna elements of the passive antenna assembly 190 and can selectively reject some frequency bands and permit other frequency bands such as those of the antenna elements 1190 of the active antenna 110 to pass therethrough by including the frequency selective surface and/or substrate to operate as a type of “spatial filter”.

Turning now to FIGS. 21A, 21B, an example passive antenna assembly 190 is shown. The antenna assembly 190 comprises multiple arrays of radiating elements, typically provided in columns, with radiating elements that extend forwardly from the reflector 170. The arrays of radiating elements of the antenna assembly 190 may comprise radiating elements 222 that are configured to operate in a first frequency band and radiating elements 232 that are configured to operate in a second frequency band. Other arrays of radiating elements may comprise radiating elements that are configured to operate in either the second frequency band or in a third frequency band. The first, second and third frequency bands may be different frequency bands (although potentially overlapping).

A respective antenna assembly 190 can be provided inside each antenna housing 100h, which can be a passive antenna assembly. The term “passive antenna assembly” refers to an antenna assembly having one or more arrays of radiating elements that are coupled to radios that are external to the passive antenna assembly, typically remote radio heads that are mounted in close proximity to the (base station) antenna housing 100h. The arrays of radiating elements included in the passive antenna assembly 190 (FIGS. 21A, 21B) are configured to form static antenna beams (e.g., antenna beams that are each configured to cover a sector of a base station). The passive antenna assembly 190 may comprise a reflector 170, with radiating elements projecting in front of the reflector and the radiating elements can include one or more linear arrays of low band radiating elements that operate in all or part of the 617-960 MHz frequency band and/or one or more linear arrays of mid-band radiating elements that operate in all or part of the 1427-2690 MHz frequency band. The passive antenna assembly 190 (FIGS. 21A, 21B) is mounted in the housing 100h of (base station) antenna 100.

Some of the radiating elements of the passive antenna assembly may be mounted to extend forwardly from the reflector 170, and, if dipole-based radiating elements are used, the dipole radiators of these radiating elements may be mounted approximately ¼ of a wavelength of the operating frequency for each radiating element forwardly of the reflector 170. The reflector 170 may serve as a reflector and as a ground plane for the radiating elements of the base station antenna 100 that are mounted thereon.

Still referring to FIGS. 21A, 21B, the passive antenna assembly 190 of the base station antenna 100 can include one or more arrays 220 of low-band radiating elements 222, one or more arrays 230 of first mid-band radiating elements 232, one or more arrays of second mid-band radiating elements 242. The radiating elements 222, 232, 242 may each be dual-polarized radiating elements. Further details of radiating elements can be found in co-pending WO2019/236203 and WO2020/072880, the contents of which are hereby incorporated by reference as if recited in full herein. Further details of an example passive base station antenna can be found in U.S. Pat. No. 10,770,803, the contents of which are hereby incorporated by reference as if recited in full herein.

It will also be appreciated that the number of arrays of low-band and mid-band radiating elements may be varied from what is shown in the figures. For example, the number of arrays of each type of radiating elements may be varied from what is shown, some types of arrays may be omitted and/or other types of arrays may be added, the number of radiating elements per array may be varied from what is shown, and/or the arrays may be arranged differently.

Each array 220-1, 220-2 of low-band radiating elements 222 may be used to form a pair of antenna beams, namely an antenna beam for each of the two polarizations at which the dual-polarized radiating elements are designed to transmit and receive RF signals. Likewise, each array 230-1, 230-2 of first mid-band radiating elements 232, and each array 242 of second mid-band radiating elements 242 may be configured to form a pair of antenna beams, namely an antenna beam for each of the two polarizations at which the dual-polarized radiating elements are designed to transmit and receive RF signals. Each linear array 220, 230, 240 may be configured to provide service to a sector of a base station. For example, each linear array 220, 230, 240 may be configured to provide coverage to approximately 120° in the azimuth plane so that the (base station) antenna 100 may act as a sector antenna for a three-sector base station. Of course, it will be appreciated that the linear arrays may be configured to provide coverage over different azimuth beamwidths. While all of the radiating elements 222, 232, 242 can be dual-polarized radiating elements in the depicted embodiments, it will be appreciated that in other embodiments some or all of the dual-polarized radiating elements may be replaced with single-polarized radiating elements. It will also be appreciated that while the radiating elements are illustrated as dipole radiating elements in the depicted embodiment, other types of radiating elements such as, for example, patch radiating elements may be used in other embodiments.

Some or all of the radiating elements 222, 232, 242 may be mounted on feed boards that couple RF signals to and from the individual radiating elements 222, 232, 242, with one or more radiating elements 222, 232, 242 mounted on each feed board. Cables (not shown) and/or connectors may be used to connect each feed board to other components of the antenna 100 such as diplexers, phase shifters, calibration boards or the like.

RF connectors or “ports” 140 (FIGS. 1, 2) can be mounted in the bottom end cap that are used to couple RF signals from external remote radio units to the arrays 220, 230, 240 of the passive antenna assembly 190. Two RF ports can be provided for each array 220, 230, 240 namely a first RF port 140 that couples first polarization RF signals between the remote radio unit and the array 220, 230, 240 and a second RF port 140 that couples second polarization RF signals between the remote radio unit and the array 220, 230, 240. As the radiating elements 222, 232, 242 can be slant cross-dipole radiating elements, the first and second polarizations may be a −45° polarization and a +45° polarization.

A phase shifter may be connected to a respective one of the RF ports 140. The phase shifters may be implemented as, for example, wiper arc phase shifters such as the phase shifters disclosed in U.S. Pat. No. 7,907,096 to Timofeev, the disclosure of which is hereby incorporated herein in its entirety. A mechanical linkage may be coupled to a RET actuator (not shown). The RET actuator may apply a force to the mechanical linkage which in turn adjusts a moveable element on the phase shifter in order to electronically adjust the downtilt angles of antenna beams that are generated by the one or more of the low-band or mid-band linear arrays 220, 230, 240.

It should be noted that a multi-connector RF port (also referred to as a “cluster” connector) can be used as opposed to individual RF ports 140 (FIG. 2). Suitable cluster connectors are disclosed in U.S. patent application Ser. No. 16/375,530, filed Apr. 4, 2019, the entire content of which is incorporated herein by reference.

The radiating elements 222 can be dipole elements configured to operate in some or all the 617-960 MHz frequency band. Further discussions of example antenna elements including antenna elements comprising feed stalks can be found in U.S. Provisional Patent Application Ser. Nos. 63/087,451 and 62/993,925 and/or related utility patent applications claiming priority thereto, the contents of which are hereby incorporated by reference as if recited in full herein.

Some or all of the low or mid-band radiating elements 222, 232, respectively, may be mounted on the feed boards 1200 and can couple RF signals to and from the individual radiating elements 222, 232. Cables (not shown) and/or connectors may be used to connect each feed board to other components of the base station antenna 100 such as diplexers, phase shifters, calibration boards or the like.

Embodiments of the invention provide PIM shields that can be integrated into OEM new builds of antenna components.

Embodiments of the invention provide PIM shields that can be provided as an aftermarket product/kit that can be used to provide PIM protection at field sites of base station antennas.

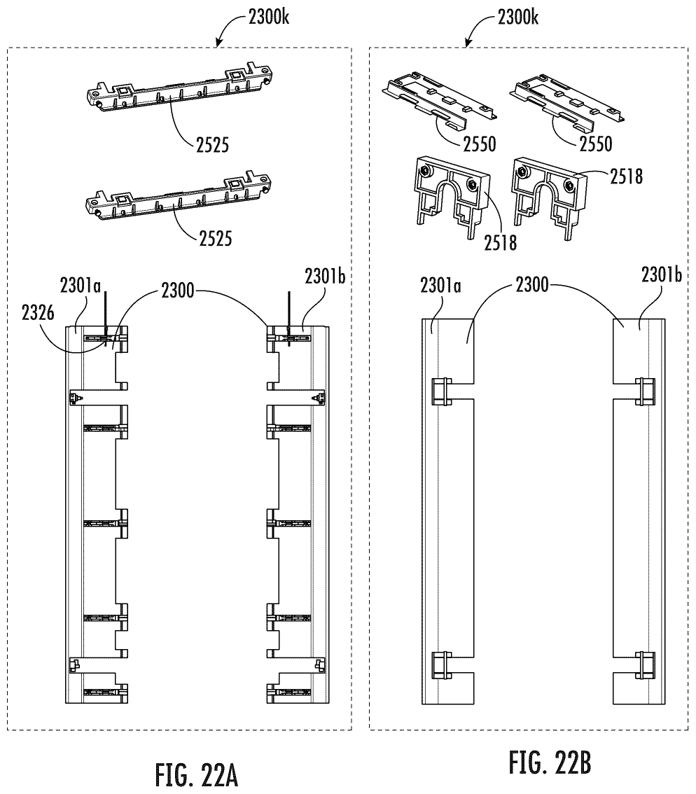

FIGS. 22A and 22B are schematic illustrations of example field retrofit kits 2300k comprising PIM shields 2300 with PIM shield bodies 2301a, 2301b and two sets of mounting hardware 2525 (FIG. 22A), and 2550 and 2518 (FIG. 22B), configured to attach to a field structure mounting bracket assembly 2500 already in position on antennas 100₁, 100₂, without requiring any dismounting of the antennas in the field for the retrofit to mount the PIM shield 2300 according to embodiments of the present invention.

Embodiments of the present invention have been described above with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.)

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

The term “about” used with respect to a number refers to a variation of +/−10%.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements, and/or components, but do not preclude the presence or addition of one or more other features, operations, elements, components, and/or groups thereof.

Aspects and elements of all of the embodiments disclosed above can be combined in any way and/or combination with aspects or elements of other embodiments to provide a plurality of additional embodiments.

1. An antenna assembly, comprising:
a first housing with a rear wall and an external front radome;
a second housing with a rear wall and an external radome positioned adjacent the first housing; and
a passive inter-modulation distortion (“PIM”) shield that is positioned to extend across at least part of the rear walls of the first and second housings.

2. The antenna assembly of claim 1, wherein the PIM shield comprises a frequency selective surface (FSS).

3. The antenna assembly of claim 1, wherein the FSS is configured to reflect or block electromagnetic waves from radiating elements of a passive base station antenna that operates in one or more lower frequency bands while allowing higher frequency band electromagnetic waves of the active antenna to travel therethrough.

4. The antenna assembly of claim 1, wherein the PIM shield comprises a first PIM shield body and a second PIM shield body, each extending longitudinally and having a lateral extent, the first shield PIM body having a rear wall residing behind the first housing and the second PIM shield body having a rear wall residing behind the second housing.

5. The antenna assembly of claim 4, wherein the first and second PIM shield bodies cooperate to define at least one channel configured to slidably receive a mounting bracket assembly.

6. The antenna assembly of claim 1, wherein the PIM shield comprises a rear wall with first and second laterally spaced apart and rearwardly extending projections that extend longitudinally along at least a portion of a length of the housing thereby providing a wind load reduction.

7. The antenna assembly of claim 2, wherein the FSS has a first pattern unit configuration at a first location and a second pattern unit configuration at a second location, and wherein the first pattern unit configuration is different than the second pattern unit configuration.

8. The antenna assembly of claim 1, wherein the PIM shield comprises first and second sidewalls that project forwardly of a rear wall thereof, and wherein the first sidewall is coupled to an outer sidewall of the first housing and the second sidewall is coupled to an outer sidewall of the second housing.

9. The antenna assembly of claim 8, wherein the first and second sidewalls are metal and devoid of the FSS.

10. The antenna assembly of claim 8, wherein the first and second sidewalls comprise an FSS.

11. The antenna assembly of claim 2, wherein the FSS is provided, at least in part, by a sheet of metal arranged to provide a grid pattern of unit cells.

12. The antenna assembly of claim 4, wherein the mounting bracket assembly comprises a field structure mounting bracket and a primary bracket, wherein the primary bracket extends laterally behind the first and second housings, wherein the first PIM shield body is attached to a first end portion of the primary bracket and the second PIM shield body is attached to a second end portion of the primary bracket and the first and second housings have a longitudinally extending gap space therebetween.

13. The antenna assembly of claim 12, wherein the first PIM shield body has an inner facing edge and the second PIM shield body has an inner facing edge, wherein the inner facing edges are spaced apart.

14. The antenna assembly of claim 12, wherein the first PIM shield body has an inner facing edge and the second PIM shield body has an inner facing edge, wherein one of the inner facing edges resides behind the other and each extends behind the gap space.

15. An antenna system comprising:
a first passive antenna comprising a first housing with a front radome and a rear wall, with a plurality of columns of first radiating elements in the first housing and configured for operating in a first operational frequency band, each column of first radiating elements comprising a plurality of first radiating elements arranged in a longitudinal direction;
a second passive antenna comprising a second housing with a front radome and a rear wall, with a plurality of columns of first radiating elements in the first housing and configured for operating in a first operational frequency band, each column of first radiating elements comprising a plurality of first radiating elements arranged in a longitudinal direction; and
a passive intermodulation (PIM) shield comprising a frequency selective surface (FSS) extending behind and across the rear wall of the first housing and the rear wall of the second housing for at least part of a length thereof, wherein the FSS is configured to reflect, absorb or block electromagnetic waves within the first operational frequency band and pass electromagnetic waves at a higher frequency band.

16. The antenna system of claim 15, wherein the PIM shield has first and second sidewalls, the first sidewall of the PIM shield extending along an outer facing sidewall of the first housing, the second sidewall of the PIM shield extending along an outer facing sidewall of the second housing.

17. The antenna system of claim 15, wherein the first housing and the second housing having inner facing sidewalls that are spaced apart by a gap space, wherein the PIM shield extends across the gap space at least for some of a longitudinal dimension of the PIM shield.

18. The antenna system of claim 15, wherein the first housing and the second housing having inner facing sidewalls that are spaced apart by a gap space, wherein the PIM shield does not extend across the gap space over at least a major portion of a longitudinal dimension of the PIM shield.

19. The antenna system of claim 15, wherein the PIM shield comprises a first longitudinally extending body coupled to a second longitudinally extending body.

20. The antenna system of claim 15, wherein the PIM shield comprises a rear wall with first and second laterally spaced apart and rearwardly extending projections that extend longitudinally along at least a portion of a length of the passive antenna thereby providing a maximum wind load reduction relative to passive antennas without the PIM shield with the first and second laterally spaced apart projections.

21. A retrofit kit for dual antennas, comprising:
a passive intermodulation (PIM) shield sized and configured to extend across rear walls of the dual antennas; and
mounting hardware configured to attach the PIM shield to a bracket assembly attached to both of the dual antennas.

22-25. (canceled)
